(19) United States
(12) Patent Application Publication
(10) Pub. No.: US 2003/0097553 A1
(43) Pub. Date: May 22, 2003

(54) PXE server appliance

(76) Inventor: James F. Frye JR., Houston, TX (US)

Correspondence Address: AKIN, GUMP, STRAUSS, HAUER & FELD, 711 LOUISIANA STREET, SUITE 1900 SOUTH, HOUSTON, TX, 77002, US

(21) Appl. No.: 09/967,615

(22) Filed: Sep. 29, 2001

(51) Int. Cl. G06F 15/177

(52) U.S. Cl. 713/2

(57) ABSTRACT

A method of directing a computer network for booting using a prebooting execution environment (PXE) appliance is provided in which the appliance listens for PXE requests from PXE enabled target servers of the network and in response provides a netboot program and address information of a boot server. An embodiment of a PXE appliance is provided that has a network interface controller, a microcontroller, and a processor. An embodiment of a system for booting a computer network using the PXE appliance is provided. The system has a target network of PXE enabled servers coupled to the PXE appliance and a boot server coupled to the PXE appliance and to the network.

### CROSS-REFERENCE TO RELATED APPLICATIONS

Not Applicable.

### STATEMENTS REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention generally relates to computer networks and more particularly to booting computer server networks.

2. Description of the Related Art

A typical process of installing a server on a network typically involves the following steps: inserting a CD, responding to questions posed by an assistant on the CD concerning the server name, IP address, hardware configuration, controller configuration, and the like. The server computer having its hardware configured reboots and performs diagnostics tests, and starts installing additional diagnostic software. This process typically takes an hour or so of the information technology person attending to the server booting process. Having configured the hardware and having performed diagnostic tests, the computer then installs the operating software. The assistant program resumes asking questions regarding the operating system configuration and other software to be installed. The process of hardware configuration, diagnostic testing, operating system installation, and software installation can take over three hours of time of the IT person. Finally, the computer configures itself using the provided information and becomes part of the network. This process of bringing servers onto the network is cumbersome for large installations.

One solution to improve bringing servers on the network of large installations is to prepare a series of scripts containing predecided responses to questions from the installation assistant and provide such a script to a new server being installed, thus substantially reducing the need of IT personnel to configure the server. In this method, some servers may require responses which are different from predecided responses on the boot floppy containing the scripts. To address this need, boot images corresponding to different servers can be stored on a boot server. When a new server is added to the network and attempts to boot, the boot server recognizes the new servers ID and provides a corresponding floppy image having the designated script thereon.

In an alternative technique, segments of the common portions of responses to the questions of the installation assistant are scripted and stored as portions of the booting process. These portions then can be used as glue objects to form a script menu of steps in a script for a particular server to use in the booting process. Such operating system scripts can also be used to install individual types of operating system, like NT, Novell, or Linux.

Another technique for initializing a large number of servers is to completely install one server using one of the above processes. Then, the entire hard drive of the installed server is compressed, copied, and provided to another new server requiring booting. The copy of the hard drive is installed on the hard drive of the new server. The new server is tailored to be identified by a different IP address and any other unique features necessary to make it part of the network.

To address the issue of booting servers, Intel Corporation of Santa Clara, Calif. has developed the Preboot Execution Environment (PXE) protocol and software. This PXE software is a part of Intel's Wired for Management (WfM) program for remote booting of servers. (Preboot Execution Environment Specification, Intel Corporation, Version 2.1, Sep. 20, 1999, incorporated by reference herein). PXE is now an industry standard in that the computer and server manufacturers manufacture their equipment to permit utilization of PXE services and familiarity with this technology is presumed. PXE has been developed to utilize industry standard Internet protocols and services, for example TCP/IP, DHCP, and TFTP. In this method, the PXE software is installed onto an NT or a Linux server. Each PXE server employs its own operating system, software applications, and other accessories for providing a host of PXE services. Servers requiring booting have their PXE environment enabled. The server requesting booting broadcasts a PXE service request. Because the PXE requests are broadcast, they are not routable. The PXE server, in response to the PXE request, sends the requesting server a list of appropriate boot servers. The requesting server approaches one of the boot servers and receives the name of an executable file on the selected boot server. The requesting server uses TFTP to download the executable from the boot server. Since the PXE requests are broadcast and are non-executable, this requires that there be a PXE server on every local subnetwork. This becomes a problem in the installations that could benefit from this technology because it increases the number of servers required to service these requests and increases complexity and burden of maintenance of additional PXE servers on the same network. Further, having these additional PXE servers on the network to service these requests or modifying existing servers that need to provide PXE services special software running on them is expensive and requires special, and therefore expensive, maintenance. Therefore, putting the PXE service onto the NT or Linux servers requires modification of the server's network setup and addition of DHCP service on each subnetwork. If the local subnet already has a DHCP server, it needs modification to not handle PXE requests so that the PXE server can handle those requests without conflict with the DHCP server. The process of setting up this service is error prone and requires significant time, investment, and testing to insure proper operation.

### BRIEF SUMMARY OF THE INVENTION

A method of directing a computer network for booting using a PXE appliance is provided in which the appliance listens for PXE requests from PXE enabled target servers of the network and in response provides a netboot program and address information of a boot server. By executing the netboot program, the target server acquires the boot server from which the server receives a boot image and other software necessary for it to become operational. An embodiment of a PXE appliance is provided that comprises a network interface controller, a microcontroller, and a processor. An embodiment of a system for booting a computer network using the PXE appliance is provided. The system comprises a target network of PXE enabled servers coupled to the PXE appliance and a boot server coupled to the PXE appliance and to the network.

This approach can provide multiple advantages. PXE server need not be provided on every subnet. An inexpensive PXE appliance instead is provided on each subnet. Further, some subnets can use the PXE appliance, while others use Legacy PXE servers.

### BRIEF DESCRIPTION OF THE SEVERAL VIEWS OF THE DRAWINGS

A better understanding of the present invention can be obtained when the following detailed description of some embodiments is considered in conjunction with the following drawings in which:

FIG. 1A is a flowchart of a method of booting servers on a network using a PXE appliance according to an embodiment of the invention.

FIG. 1B is a flowchart of an example net boot program for using with a PXE appliance according to an embodiment of the invention.

FIG. 2 is a diagram of a system of booting servers on a network using a PXE appliance.

FIG. 3 is an example embodiment of a PXE appliance.

### DETAILED DESCRIPTION OF THE INVENTION

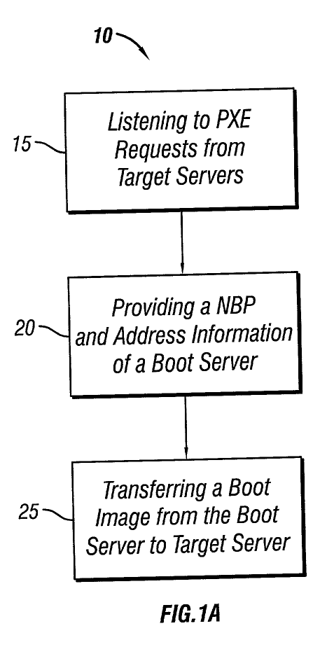

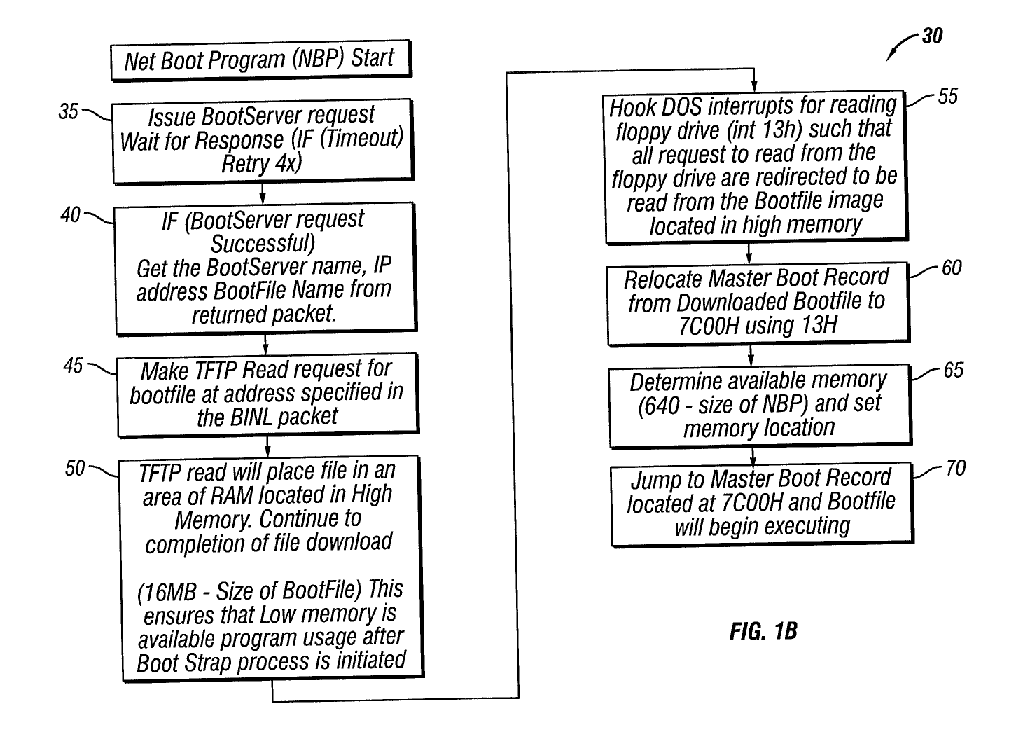

With reference to FIGS. 1, 2, and 3, an example embodiment of a method 10 of directing a computer network 115 for booting using a prebooting execution environment (PXE) appliance 120 is illustrated. A network 115 of target servers may comprise several of subnetworks 112, 114. The number of target servers in each subnetwork is decided by each installation. A PXE appliance is preferably coupled to each subnetwork 112, 114. Each target server utilizing the method 10, has its PXE enable option turned on. The PXE appliances 120 and the network 115 form a local network where local broadcasts may be utilized for communication between the servers and the PXE appliance 120. When target server booting is desired, the target server broadcasts a PXE request over the local subnetwork. In step 15 of the method 10, the PXE appliance 120 listens to PXE requests from the target servers of the network 115. In the illustrated embodiment, at least one PXE appliance 120 listens to one of the subnetworks 110 or 112. The listening step 15 of the method 10 is preferably performed through a TCP/IP stack. The PXE appliance 120, in response to PXE requests, provides a net boot program (NBP) and address information of a boot server to the requesting target servers. In the illustrated embodiment, the address information of the boot server 130 is an IP address over the network. The NBP is a small, executable program that directs the server to the boot server. The NBP is typically a vendor provided program for the PXE software written in accordance with the PXE specification. An example of the NBP is described in more detail in the next paragraph. Also, in the illustrated embodiment, the boot image 140 may be provided through a router 125. In the illustrated embodiment, the boot image 140 comprises responses to PXE queries for the target server requesting a boot image. The PXE appliance 120 is capable of listening to one or more target servers at the same time. If the target servers do not have the PXE enablement turned on, the PXE appliance ignores any broadcasts from those servers. In step 25, the target server 110 executes the net boot program and by executing that program it requests, the boot server 130 to transfer a boot image 140 for that particular target server using standard routing. This allows a single or reduced number of boot servers to service multiple sub networks. In this advantageous method, the target server 110 receives the NBP from the appliance 120 in response to its broadcast. By executing the NBP the server 110 can obtain the boot image 140 from a centralized boot server 130.

FIG. 1B is a flowchart of an example Compaq NBP 30 for using with the PXE appliance 120 for a Compaq system according to an embodiment of the invention. In step 35, the NBP 30 issues a boot server request. In step 40, the appliance 120 receives the boot server information. This information includes IP address of the boot server, which could be different from the IP address of the appliance 120. In step 45, using the IP address of the boot server 130 and the boot image name, the appliance 120 issues a TFTP request for that boot image. In step 50, the content of the boot image is an image of the bootable floppy 140 (1.44 or 2.88 MB in size), once this floppy has been downloaded and placed into high memory of a server 110. In step 55, the NBP can Hook the DOS interrupt for Disk I/O int 13h. This means that any int 13h calls that are generated will go first to the appliance code and not the standard ROM bios routine. In step 60, the appliance software in the interrupt call determines what the target of the disk I/O request is and if it is a floppy sector read or write, it is directed to the boot image loaded into the high memory. Any other requests are forwarded on to the standard int 13h routine. In step 65, the first read in the process of booting a computer is to read the master boot record from the floppy. The master boot record is copied to 7c00h in memory. This is the standard boot mechanism. Once the NBP jumps to the 7c00h the booting process starts and the NBP execution is terminated. In step 65, the process of booting is handed off to the OS loader present on the floppy. In step 70, the configuration script is executed from the floppy. This process of PXE booting repeats several times as required by the script that configures the server. State information is kept such that after each reboot the system re-enters the script at the appropriate place until booting is complete.

Execution of the net boot program provides server communication with the boot server 130 where the server 110 identities by its IP address and in response an associated boot image 140 is provided to the requesting target server. Typically, the boot server 130 stores a database of boot images, operating systems, and application software on a storage medium, for example a hard drive 135. In one embodiment of the method 10, the boot server stores boot images specific to each target server 110 and links a specific boot image to a specific target server's 110 ID. The boot images 140 corresponding to each target server 110 may comprise a script specific to the requesting target server. Thus, when the boot server 130 receives a request from a particular target server 110, it looks in its database and links a particular boot image to that server's ID and transfers that boot image to the target server 110. Typically, a boot image also may comprise code to install at least one operating system on a requesting server, for example, NT or Linux. In this manner, even headless servers, i.e. having no CD, floppy or hard drive, can be booted and provided with the desired operating system and application software. The boot image 140 may also contain code for a certain desired application software, for example, word processing, email, Internet access, etc.

In one embodiment, a net boot program can be stored in a “read-only” type memory (i.e., Flash memory) of the target server, and subsequently executed out of that read-only memory in the target server 110. When the boot image 140 is transferred from the boot server 130 in response to executing the net boot program, the boot image 140 is transferred using a trivial file transfer protocol (TFTP) that is part of the PXE services. Thus, the target server 110 receives a booting script through execution of which it also receives operating software, application software like TFTP, and any other applications that are included in the script. An example of a simple Compaq specific boot script with self explanatory comments is provided following this paragraph. In the example script, the first step is to check the current state of the server configuration process. This information is kept on the server in some nonvolatile RAM. Some steps in the boot script require computer reboots between successive step to allow the ROM to incorporate the change before allowing additional configuration steps. After each reboot the PXE process is repeated and the boot image is downloaded and process picks up at the same point. The example boot script is arranged in four phases based on the state process. The four phases in this example accomplish following aspects of the booting process:

Phase 1

1. Configure the System Hardware (mother board)

2. Configure the Array controller(s) if any are present

3. Set the state to the next phase

4. Reboot

Phase 2

1. Create a boot partition and Special partition (optional)

2. Set the state to the next phase

3. Reboot

Phase 3

1. Format and populate the boot and special partition(s) as required by the OS installation

2. Set special partition type to hidden (if there is one)

3. Set the state to the next phase

4. Launch The OS install using unattended script capabilities of The OS installer.

Phase 4

1. Complete OS installation by updating Compaq drivers

2. Launch any other application installation processes as indicated by customers internal build requirements.

Example Boot script:

@ECHO OFF
CLS
REM ***
----------------------------------------------------------
REM *** Ensure that the shared network directory is used and get
REM *** the current state
REM ***
----------------------------------------------------------
S:
CD \CPQ
ECHO Retrieving State Information...
S:\CPQ\STATEMGR /r Phase
REM ***
----------------------------------------------------------
REM *** Remove this initial pause when the batch file has been full
REM *** tested and debugged
REM ***
----------------------------------------------------------
REM ***
----------------------------------------------------------
REM *** Established DOS error levels and branching in declining order
REM ***
----------------------------------------------------------
IF ERRORLEVEL 10 GOTO State10
IF ERRORLEVEL 9 GOTO State9
IF ERRORLEVEL 8 GOTO State8
IF ERRORLEVEL 7 GOTO State7
IF ERRORLEVEL 6 GOTO State6
IF ERRORLEVEL 5 GOTO State5
IF ERRORLEVEL 4 GOTO State4
IF ERRORLEVEL 3 GOTO State3
IF ERRORLEVEL 2 GOTO State2
IF ERRORLEVEL 1 GOTO State1
IF ERRORLEVEL 0 GOTO State0
:State0
REM ***
----------------------------------------------------------
REM *** First state
REM *** Configure the target server hardware by reading the
REM *** configuration information in the script file
S:\SERVERS\DL380\DL380NT.HWR
REM *** Increment the state variable
REM ***
----------------------------------------------------------
ECHO Running Configuration Replication Utility...
S:\CPQ\CONREP −1 S:\DL380\SYSTEM.DAT
ECHO Setting State Information...
S:\CPQ\STATEMGR /w Phase 1
REM ----- Second State Configure Array ---------
:State1
REM ***
----------------------------------------------------------
REM *** Second state
REM *** Configure the array controllers by reading the configuration
REM *** information in the script file
S:\SERVERS\DL380\DL380NT.ARY and
REM *** stamping it onto the array controllers of the target server
REM *** Increment the state variable and reboot
REM ***
----------------------------------------------------------
ECHO Configuring the Array Controllers...
S:\CPQ\ACR /I S:\DL380\ARRAY.INI/o
echo Setting State Information...
ECHO Setting State Information...
S:\CPQ\STATEMGR /w Phase 2
REM ***
----------------------------------------------------------
REM *** Reboot to drive A:
REM ***
----------------------------------------------------------
S:\CPQ\BOOT a:
:State2
REM ***
----------------------------------------------------------
REM *** Third state
REM *** Create partition by reading content of file
REM *** S:\SERVERS\DL380\DL380NT.PRT script file and stamping
REM *** the configuration onto the hard drive in the target server
REM *** Prepare for system partition population
REM *** Increment state variable and reboot
REM ***
----------------------------------------------------------
ECHO Creating Disk Partition...
S:\CPQ\CPQDISK /w S:\DL380\DISKPART.INI
S:\CPQ\SYSPART /update: enable
ECHO Setting State Information...
S:\CPQ\STATEMGR /w Phase 3
REM ***
----------------------------------------------------------
REM *** Reboot to drive A:
REM ***
----------------------------------------------------------
S:\CPQ\BOOT a:
:State3
REM ***
----------------------------------------------------------
REM *** Fourth State
REM *** Populate the system partition
REM *** Increment the state variable and reboot
REM ***
----------------------------------------------------------
ECHO Populating System Partition...
S:\CPQ\SYSPART /update: disable
C:\
CD\
S:\CPQ\PSYSPART /s:S:
ECHO Setting State Information...
S:\CPQ\STATEMGR /w Phase 4
REM ***
----------------------------------------------------------
REM *** Before this reboot, the system partition is C: and the DOS
REM *** partition is D: If you want to remove this reboot, use D:
REM *** instead of C: when referring to the DOS partition until a
REM *** reboot is done Reboot to drive A:
REM ***
----------------------------------------------------------
S:\CPQ\BOOT a:
:State4
REM ***
----------------------------------------------------------
REM *** Fifth State
REM *** Format the boot partition and populate
REM *** Increment the state variable
REM ***
----------------------------------------------------------
ECHO Formatting the First Disk Partition as DOS...
S:\CPQ\CPQFMT C:
C:
CD\
ECHO Create Driver Directory and Copy Drivers...
MKDIR $OEM$
S:

In another embodiment, the boot server provides the same boot image to every requesting target server 110. However, the boot image 140 comprises an inside script within a main script. The main script has the common responses for each target server. The other script within the main script has responses and other actions specific to various target servers. Each target server 110 is capable of recognizing information specific to it from the inside script and executes that specific information. This embodiment is advantageous because the boot server 130 provides the same boot image to every requesting target server.

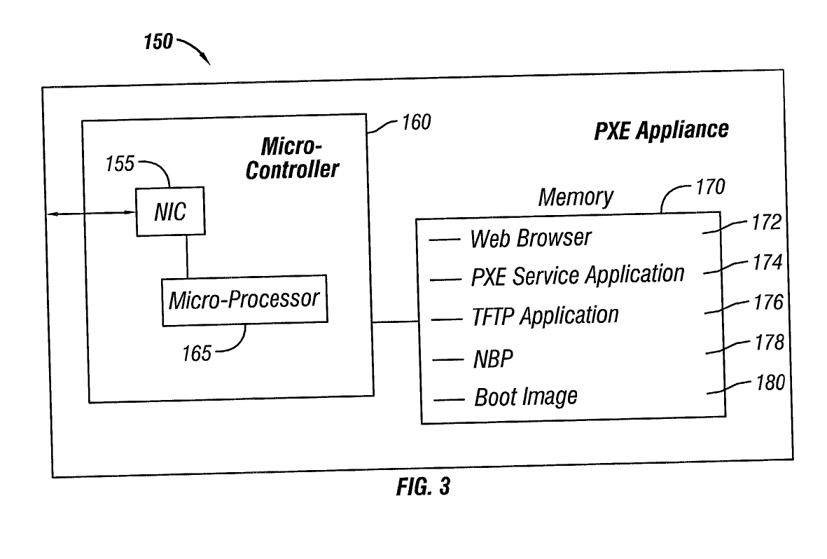

With reference to FIG. 3, an embodiment of a prebooting execution environment appliance 150 (PXE appliance) is illustrated. In the illustrated embodiment, the appliance includes a microcontroller 160, for example with NIC 155 coupled to the NIC 155 functional core; and a processor 165 as part of the microcontroller. The appliance 150 is provided with minimum hardware and software so that anytime a target server requests booting, the PXE appliance 150 provides enough services to direct the requesting server to the boot server 130. The processor 165 executes preboot execution environment routing software that can perform the following functions: listen to the PXE requests 117 from the PXE enabled target servers 110 of subnets 112 and 114 of the computer network 115; in response to the PXE request from the requesting server 110, provide a network boot program and address information of a boot server 130 to the requesting server 110. This embodiment of the PXE appliance 120 provides minimal services, whereas the boot server 130 can provide maximum amount of services that are included by a particular installation. This embodiment has several advantages. For example when the installation implements an operating system change, or other system changes, there is no need to implement the changes to the PXE appliances on an installation wide basis, unlike in the Intel PXE server architecture wherein each PXE server will require corresponding changes implemented therein. Moreover, integrity of the services through one boot server is easily maintained to provide reliable server booting. The PXE appliance 150 is provided with a memory 170 coupled to the microprocessor 165. The memory 170 may be RAM, Flash memory, other available forms of memory or combinations thereof. In one embodiment, the memory 170 is 4 Mb RAM and 2 Mb Flash memory. The memory 170 may have a web browser 172, PXE service applications 174, a TFTP application 176, a network boot program 178, and a boot image 180. In this embodiment, the appliance may retain a boot image 180 that was received from the boot server and subsequently provide it to many different requesting servers as needed, for example, when many servers in a sequence may be requesting the same boot image 180, the PXE appliance 150 may be readily able to provide that stored boot image 180. However, when another server, for example, requests a different boot image, the process outlined above is used, and that particular boot image may be retained in the PXE appliance 150 for repeated usage, until a request for a new boot image is received. The PXE appliance 150 can be configured remotely through the web browser 172. This is advantageous in updating any appliance software and updating any changed or new IP addresses of the boot server 130. In an exempary embodiment of the PXE appliance, a NetSilicon (of Waltham Mass.) ASIC, part number NET+50 32-Bit Ethernet System on a chip for device networking was programmed in accordance with the PXE specification to provide a net boot program and address of the bootserver. A person of ordinary skill may be able to use other known ASICs, or other hardware configuration having approximate hardware capabilities: a 32-bit Micro Controller, a 10/100BaseT Ethernet Media Access Controller, Asynchronous Serial port(s), Programmable Memory Controller, 2+MB Flash memory and a small amount of SDRam, Bi-directional I/O ports (leads/switches), Mechanical enclosure/connectors, and a DC power supply and the noted programming to make a PXE appliance.

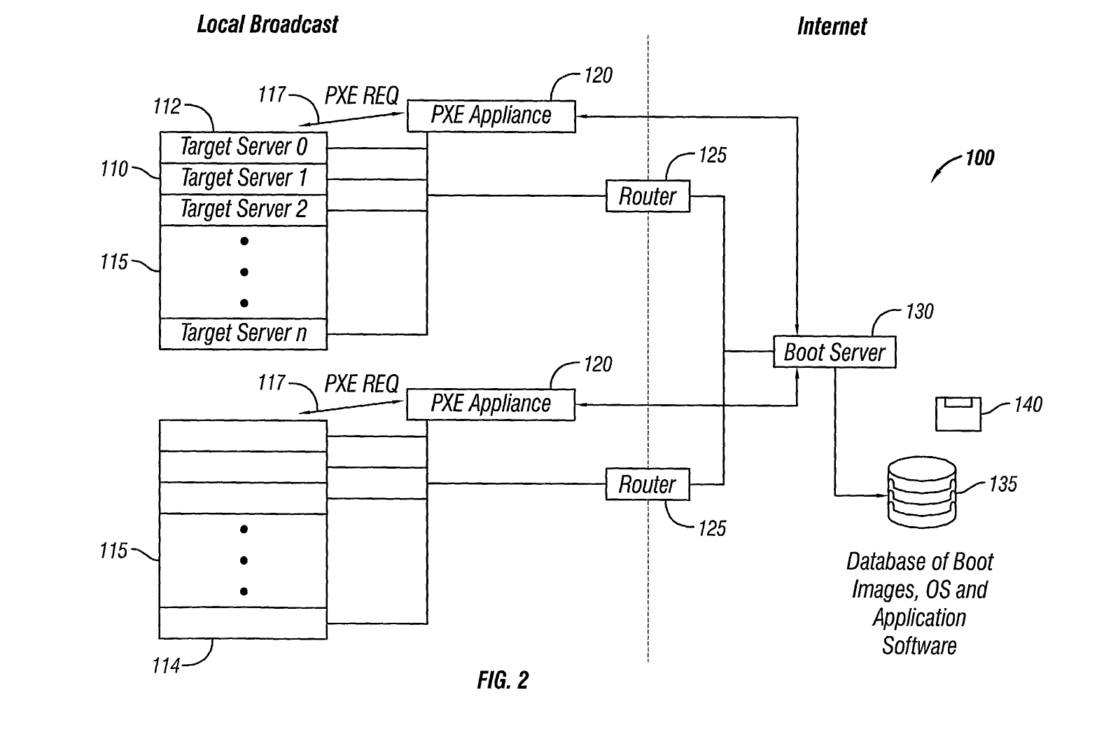

With reference to FIG. 2, a system 100 for booting a computer network 115 is illustrated. A target network 115 of PXE enabled servers has subnetworks, for example subnetwork 112 and subnetwork 114, wherein each of the subnetworks is coupled to a corresponding PXE appliance 120. The PXE appliance 120 listens to the PXE requests from servers in the target network 115 and answers with a net boot program and an IP address of a boot server 130 to the requesting target server. A boot server 130 is coupled to the PXE appliance through an IP socket communication for requesting images or other necessary configuration data. The boot server 130 may be coupled to the network through routers 125. The boot server 130 may be coupled to the network 115 without a router as well. As noted above, the appliance 120 is configurable through the web browser 172. This functionality can be advantageously utilized in configuring the system 100 as well. As another alternative, the PXE appliance 120 may be additionally included in one of the server 110 of the subnetwork 112 and 114. In this alternative some rack space may be saved, specially in dense line server configurations.

The foregoing disclosure and description of the preferred embodiment are illustrative and explanatory thereof, and various changes in the components, circuit elements, circuit configurations, and signal connections, as well as in the details of the illustrated circuitry and construction and technique of operation may be made without departing from the spirit and scope of the invention.

What is claimed is:

1. A method of directing a computer network for booting using a prebooting execution environment (PXE) appliance, the method comprising:
listening to PXE requests from a plurality of PXE enabled target servers of a computer network; and
providing to one of the plurality of PXE enabled target servers a netboot program and address information of a boot server from the PXE appliance responsive to a PXE request from one of the PXE enabled target servers.

2. The method as in claim 1, wherein the computer network comprises a plurality of subnetworks of PXE enabled target servers.

3. The method as in claim 2, wherein at least one PXE appliance listens to one of the subnetwork

4. The method as in claim 1, wherein the plurality of PXE enabled target servers are part of a subnetwork of the computer network.

5. The method as in claim 1, wherein the listening step is performed through a TCP/IP stack.

6. The method as in claim 1, wherein the address information of the boot server comprises an IP address.

7. The method as in claim 1, further comprising transferring a boot image from the boot server responsive to netboot program executing on one of the PXE enabled target server.

8. The method as in claim 7, wherein the boot image is provided through a router.

9. The method as in claim 7, wherein the boot image comprises responses to preboot execution environment queries.

10. The method as in claim 7, wherein the boot image further comprises a script specific to the requesting target server.

11. The method as in claim 7, wherein the boot image comprises code to install at least one operating system.

12. The method as in claim 7, wherein the boot image comprises application software.

13. The method as in claim 7, wherein the netboot program is executed out of a read-only memory.

14. The method as in claim 7, wherein the boot image is transferred using a trivial file transfer protocol.

15. The method as in claim 7, wherein the PXE enabled server is booted by executing the boot image.

16. A prebooting execution environment (PXE) appliance comprising:
a network interface controller (NIC);
a microcontroller coupled to the NIC;
a microcontroller executable preboot execution environment routing software, which is adapted to perform the microcontroller executable steps of:
listening to PXE requests from a plurality of PXE enabled target servers of a computer network; and
providing to one of the plurality of PXE enabled target servers a netboot program and address information of a boot server from the PXE appliance responsive to a PXE request from one of the PXE enabled target servers.

17. The appliance as in claim 16, further comprising a memory coupled to the processor.

18. The appliance as in claim 17, wherein the memory further comprises:
a web browser;
PXE service applications;
a TFTP application;
a Net Boot Program (NBP); and
a boot image.

19. The appliance as in claim 18, wherein the appliance is configured through the web browser.

20. The appliance as in claim 16, wherein the NIC is implemented as part of the microcontroller.

21. A system for booting a computer network, the system comprising:
a target network of PXE enabled servers;
a PXE appliance adapted to be coupled to the target network, the PXE appliance comprising:
a network interface controller (NIC);
a microcontroller coupled to the NIC; and
a microcontroller executable preboot execution environment routing software, which is adapted to perform the microcontroller executable steps of:
listening to PXE requests from a plurality of PXE enabled target servers of a computer network; and
providing to one of the plurality of PXE enabled target servers a netboot program and address information of a boot server from the PXE appliance responsive to a PXE request from one of the PXE enabled target servers; and
a boot server coupled to the PXE appliance and to the network.

22. The system as in claim 21, further comprising a memory coupled to the processor.

23. The system as in claim 22, wherein the memory further comprises:
a web browser;
PXE service applications;
a TFTP application;
a Net Boot Program (NBP); and
a boot image.

24. The system as in claim 21, wherein the appliance includes at least one PXE application to provide desired PXE services.

25. The system as in claim 21, wherein the computer network comprises a plurality of subnetworks of PXE enabled target servers.

26. The system as in claim 21, wherein at least one PXE appliance listens to one of the subnetwork.

27. The system as in claim 21, wherein the data transfer protocol comprises trivial file transfer protocol (tftp).

28. The system as in claim 21, wherein the boot server provides the boot image for each target server on the computer network.
